(19) United States
(12) Patent Application Publication
(10) Pub. No.: US 2022/0277512 A1
(43) Pub. Date: Sep. 1, 2022

(54) GENERATION APPARATUS, GENERATION METHOD, SYSTEM, AND STORAGE MEDIUM

(71) Applicant: CANON KABUSHIKI KAISHA, Tokyo (JP)

(72) Inventor: Hiroyasu Ito, Tokyo (JP)

(21) Appl. No.: 17/667,588

(22) Filed: Feb. 9, 2022

(30) Foreign Application Priority Data
Mar. 1, 2021 (JP) 2021-032037

(51) Int. Cl. G06T 15/40; G06T 17/20; G06T 15/20; G06T 15/50; G06N 20/00; G06T 7/90

(52) U.S. Cl. CPC G06T 15/40; G06T 17/20; G06T 15/20; G06T 15/503; G06N 20/00; G06T 7/90; G06T 2207/30201

(57) ABSTRACT

A generation apparatus obtains an image captured by shooting an object with a plurality of image capturing devices, specifies a transparent part included in the object or a transparent part contacting the object in the obtained image, and generates a three-dimensional shape data of the object, not including the specified transparent part.

### BACKGROUND

### Field

The present disclosure relates to a generation technique of three-dimensional shape data of an object.

### Description of the Related Art

In recent years, a technique is drawing attention that performs synchronized shooting from a plurality of viewpoints with a plurality of cameras installed at different positions and generates an image (virtual viewpoint image) from an arbitrary virtual camera (virtual viewpoint), using a plurality of images obtained by the shooting. Such a technique allows for viewing, for example, highlight scenes of soccer or basketball games from various angles, making it possible to provide users with enhanced realistic sensation compared with normal video contents.

In order to generate a virtual viewpoint image, three-dimensional shape data (hereinafter, 3D model) of an object may be used. Assuming that a person wearing eyeglasses is an object for which a 3D model is to be generated, the 3D model may be created with lenses (transparent parts) of the eyeglasses included therein. FIG. 17 illustrates an example of a virtual viewpoint image based on a 3D model of a person wearing eyeglasses. In the virtual viewpoint image generated according to the volume intersection method, as illustrated in FIG. 17, textures of eyes are pasted on the lens parts of the eyeglasses, not on the face. And thus, there arises a problem that an image is created with the eyes protruding from the face, giving a sense of unnaturalness.

On the other hand, Japanese Patent Laid-Open No. 2010-072910 (hereinafter, Literature 1) discloses technique including an eyeglass-removing unit configured to remove pixel values of an eyeglass frame part, a naked-eye face model generating unit configured to generate a 3D model of a naked-eye face, an eyeglasses model generating unit configured to generate a 3D model of a pair of eyeglasses, and a model integration unit configured to integrate the 3D model of the naked-eye face and the 3D model of the pair of eyeglasses.

However, the technique according to Literature 1 requires to perform a tracking process of a feature point arranged on the eyeglass frame to generate the 3D model of the pair of eyeglasses, which increases a generation load.

### SUMMARY

The present disclosure provides a technique for reducing the load of generating a three-dimensional model including a transparent part.

According to one aspect of the present disclosure, there is provided a generation apparatus comprising: one or more memories storing instructions; and one or more processors that, upon executing the stored instructions, perform: obtaining an image captured by shooting an object with a plurality of image capturing devices; specifying, in the obtained image, a transparent part included in the object or a transparent part contacting the object; and generating a three-dimensional shape data of the object, not including the specified transparent part.

According to another aspect of the present disclosure, there is provided a system comprising: one or more memories storing instructions; and one or more of processors that, upon executing the stored instructions, perform: obtaining an image captured by shooting an object with a plurality of image capturing devices; specifying, in the obtained image, a transparent part included in the object or a transparent part contacting the object; generating a three-dimensional shape data of the object, not including the specified transparent part; obtaining virtual viewpoint information for specifying a position of a virtual viewpoint and a view direction from the virtual viewpoint; and generating a virtual viewpoint image representing appearance from the virtual viewpoint, based on the generated three-dimensional shape data, and images obtained with one or more image capturing devices selected from the plurality of image capturing devices based on the virtual viewpoint information.

According to another aspect of the present disclosure, there is provided a generation method comprising: obtaining an image captured by shooting an object with a plurality of image capturing devices; specifying, in the obtained image, a transparent part included in the object or a transparent part contacting the object; and generating a three-dimensional shape data of the object, not including the specified transparent part.

According to another aspect of the present disclosure, there is provided a non-transitory computer-readable storage medium storing a program that causes a computer to execute a generation method, the method comprising: obtaining an image captured by shooting an object with a plurality of image capturing devices; specifying, in the obtained image, a transparent part included in the object or a transparent part contacting the object; and generating a three-dimensional shape data of the object, not including the specified transparent part.

Further features of the present disclosure will become apparent from the following description of exemplary embodiments with reference to the attached drawings.

### BRIEF DESCRIPTION OF THE DRAWINGS

FIG. 1 illustrates an example of a configuration of an image processing system;

FIG. 2 illustrates a functional configuration example of an image processing apparatus according to a first embodiment;

FIG. 3 illustrates a hardware configuration example of the image processing apparatus;

FIG. 4 is a flowchart of a process executed by a 3D model generating unit:

FIG. 5A illustrates an example of a foreground image:

FIG. 5B illustrates an example of a silhouette image;

FIG. 6 is a schematic diagram of generation of a 3D model according to the volume intersection method:

FIGS. 7A to 7D are explanatory diagrams of generation of a 3D model of the head of a person wearing eyeglasses according to the volume intersection method:

FIG. 8 is a flowchart of a process executed by a transparent part specifying unit:

FIG. 9 is an explanatory diagram of calculation of 3D spatial coordinates;

FIG. 10 is an explanatory diagram of a 3D model correction process.

FIG. 11 is a flowchart of a process executed by a rendering unit according to the first embodiment;

FIG. 12 illustrates an example of a virtual viewpoint image according to the first embodiment.

FIG. 13 illustrates a functional configuration example of an image processing apparatus according to a second embodiment;

FIG. 14 is a flowchart of a process executed by a rendering unit according to a third embodiment;

FIG. 15 is an explanatory diagram of a process executed by the rendering unit according to the third embodiment;

FIG. 16 is an explanatory diagram of a process executed by the rendering unit according to the third embodiment; and

FIG. 17 illustrates an example of a conventional virtual viewpoint image.

### DESCRIPTION OF THE EMBODIMENTS

Hereinafter, embodiments will be described in detail with reference to the attached drawings. Note, the following embodiments are not intended to limit the disclosure. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### (Configuration of Image Processing System)

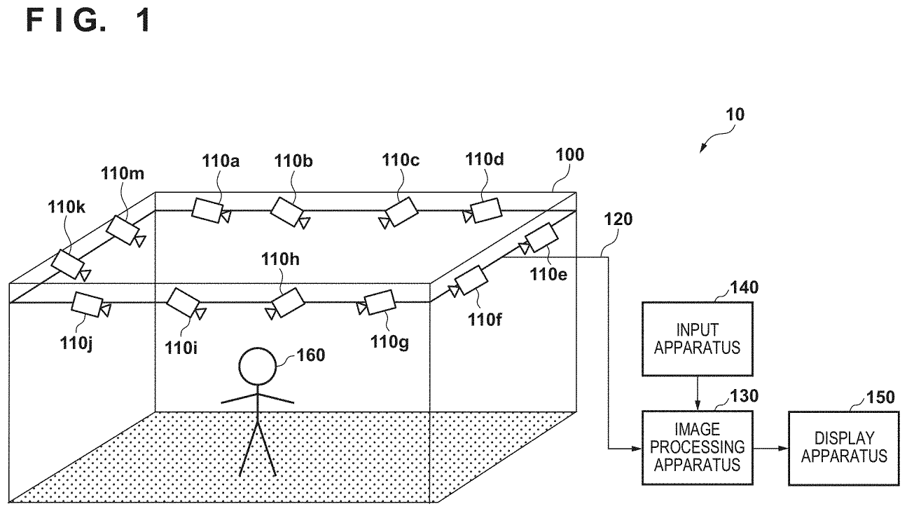

FIG. 1 illustrates an example of a configuration of an image processing system according to the present embodiment. An image processing system 10 is a system configured to generate a virtual viewpoint image representing appearance from a specified virtual viewpoint, based on a plurality of images obtained by image capturing with a plurality of image capturing devices and the specified virtual viewpoint. The virtual viewpoint image in the present embodiment, also referred to as a free-viewpoint video, is not limited to an image corresponding to a viewpoint freely (arbitrarily) specified by a user and also includes an image corresponding to the viewpoint selected by the user from a plurality of candidates. In addition, although the present embodiment mainly describes a case where specification of a virtual viewpoint is performed by user operation, specification of the virtual viewpoint may be performed automatically based on the result of the image analysis or the like. In addition, although the present embodiment mainly describes on a case where the virtual viewpoint image is a video, the virtual viewpoint image may be a still image.

In the present embodiment, a plurality of cameras 110a to 110m serving as a plurality of image capturing devices are arranged in a manner surrounding the interior of a studio 100 in which images are supposed to be captured. Here, the number of cameras and the arrangement are not limited thereto. The cameras 110a to 110m are connected to an image processing apparatus 130 via a network 120. The image processing apparatus 130 has connected thereto an input apparatus 140 configured to provide a virtual viewpoint, and a display apparatus 150 configured to display a generated (created) virtual viewpoint image. A subject 160 represents a person as an example of a target to be captured.

(Configuration of Image Processing Apparatus 130)

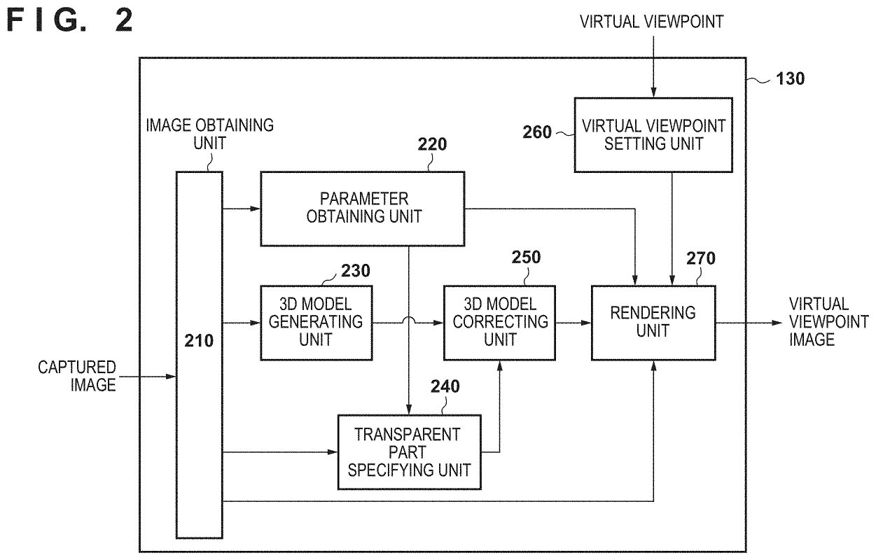

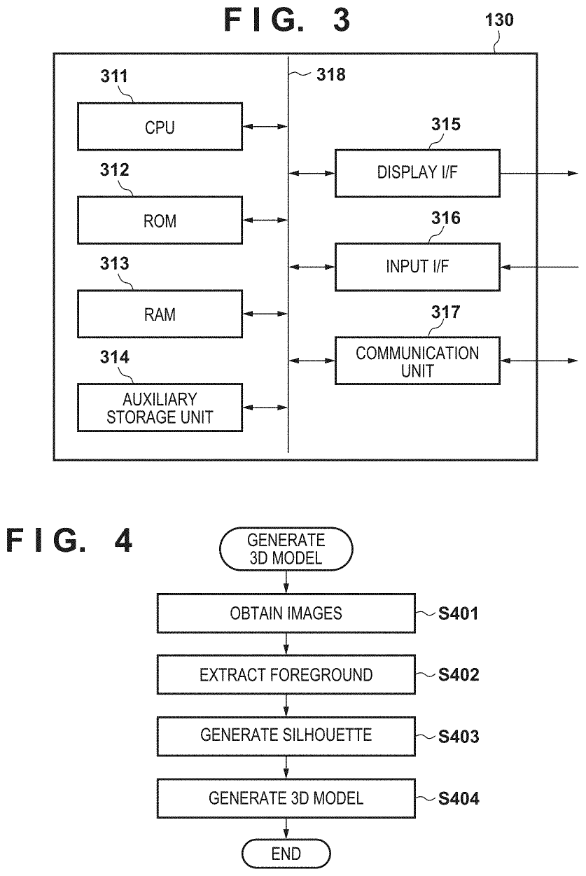

FIGS. 2 and 3 respectively illustrate an example of a (software) functional configuration and a hardware configuration of the image processing apparatus 130 according to the present embodiment. First, a functional configuration of the image processing apparatus 130 according to the present embodiment will be described, referring to FIG. 2. An image obtaining unit 210 obtains images (captured images/camera images) obtained by image capturing with the plurality of cameras 110a to 110m. A parameter obtaining unit 220 performs calibration by taking a matching of feature points from data of the images obtained by the plurality of cameras 110a to 110m, and derives (obtains) parameters representing the position, posture, and angle of view of each of the plurality of cameras 110a to 110m. Hereinafter, the parameters will be referred to as camera parameters. A three-dimensional shape data (three-dimensional model) generating unit 230 generates a 3D model (three-dimensional shape data) based on data of images obtained by the plurality of cameras 110a to 110m, and the camera parameters. Generation of the 3D model will be described in detail below.

A transparent part specifying unit 240 recognizes a part which is transparent (transparent part) in the image obtained by the plurality of cameras 110a to 110m such as a lens of the eyeglasses, and specifies (identifies) an object including the transparent part. The transparent part is supposed to be transparent to at least visible light. In addition, the transparent part specifying unit 240 calculates spatial coordinates of the transparent part, based on the camera parameters. A 3D model correcting unit 250 performs correction, based on the spatial coordinates of the transparent part calculated by the transparent part specifying unit 240, by deleting the 3D model of the transparent part located at the coordinates on the 3D model (hereinafter referred to as transparent part model). A virtual viewpoint setting unit 260 obtains, and sets to a rendering unit 270, a virtual viewpoint input from the input apparatus 140. Input of the virtual viewpoint from the input apparatus 140 is performed by user operation or the like, on the input apparatus 140. The virtual viewpoint to be input is input as virtual viewpoint information for specifying a position of the virtual viewpoint and a view direction from the virtual viewpoint. It suffices that the transparent part is transparent to visible light. In addition, the transmittance of the transparent part need not be uniform to visible light, and may be translucent or opaque to light of a particular color.

A rendering unit 270 functions as an image generation unit configured to generate a virtual viewpoint image representing appearance from the virtual viewpoint, based on the 3D model corrected by the 3D model correcting unit 250, and images obtained by one or more image capturing devices selected from the plurality of image capturing devices based on the virtual viewpoint information. Specifically, the rendering unit 270 applies the image obtained by the image obtaining unit 210 to the 3D model corrected by the 3D model correcting unit 250 to perform rendering (color selection, coloring/texture pasting). The rendering process is performed based on the virtual viewpoint obtained by the virtual viewpoint setting unit 260 and, as a result, the virtual viewpoint image is output.

Next, a hardware configuration of the image processing apparatus 130 will be described, referring to FIG. 3. The image processing apparatus 130 includes a Central Processing Unit (CPU) 311, a Read Only Memory (ROM) 312, a Random Access Memory (RAM) 313, an auxiliary storage unit 314, a display interface 315, an input interface 316, a communication unit 317, and a bus 318.

The CPU 311 realizes respective functions of the image processing apparatus 130 illustrated in FIG. 2 by controlling the entire image processing apparatus 130 using computer programs and data stored in the ROM 312 or the RAM 313. Here, the image processing apparatus 130 may include one or more dedicated hardware different from the CPU 311, and the dedicated hardware may execute at least some of the processes supposed to be performed by the CPU 311. Examples of dedicated hardware include Application Specific Integrated Circuit (ASIC), Field Programmable Gate Array (FPGA), Digital Signal Processor (DSP) and the like. The ROM 312 stores programs or the like that do not require modification. The RAM 313 temporarily stores programs or data supplied from the auxiliary storage unit 314, and data or the like supplied from outside via the communication unit 317. The auxiliary storage unit 314, which is formed by a hard disk drive, for example, stores various types of data such as image data, audio data or the like.

The display Interface (I/F) 315, which is an interface for a liquid crystal display or an LED, for example, displays a Graphic User Interface (GUI) to be operated by the user, a virtual viewpoint image or the like. The input interface 316 connects an equipment for inputting operations by the user such as a keyboard, a mouse, a joystick, a touch panel, for example, or an equipment for inputting virtual viewpoint information.

The communication unit 317 is used for communication with devices outside the image processing apparatus 130. For example, when wire-connecting the image processing apparatus 130 to an external device, a communication cable is connected to the communication unit 317. In a case where the image processing apparatus 130 has a function of performing wireless communication with an external device, the communication unit 317 includes an antenna. In the present embodiment, the input apparatus 140 is connected to the input interface 316, and the display apparatus 150 is connected to the display interface 315. The virtual viewpoint is input from the input apparatus 140, and the generated virtual viewpoint image is output to the display apparatus 150. The bus 318, connecting respective units of the image processing apparatus 130, transmits information.

Although it is assumed in the present embodiment that the input apparatus 140 and the display apparatus 150 exist outside the image processing apparatus 130, at least one of the input apparatus 140 and the display apparatus 150 may exist inside the image processing apparatus 130 as the input unit or the display unit.

(3D Model Generation Process)

Next, a 3D model generation process according to the present embodiment will be described, referring to FIGS. 4 to 7D. FIG. 4 is a flowchart of a process executed by the 3D model generating unit 230. The flowchart illustrated in FIG. 4 may be realized by executing, by the CPU 311 of the image processing apparatus 130, a control program stored in the ROM 312 or the like to calculate and process information, and control each hardware.

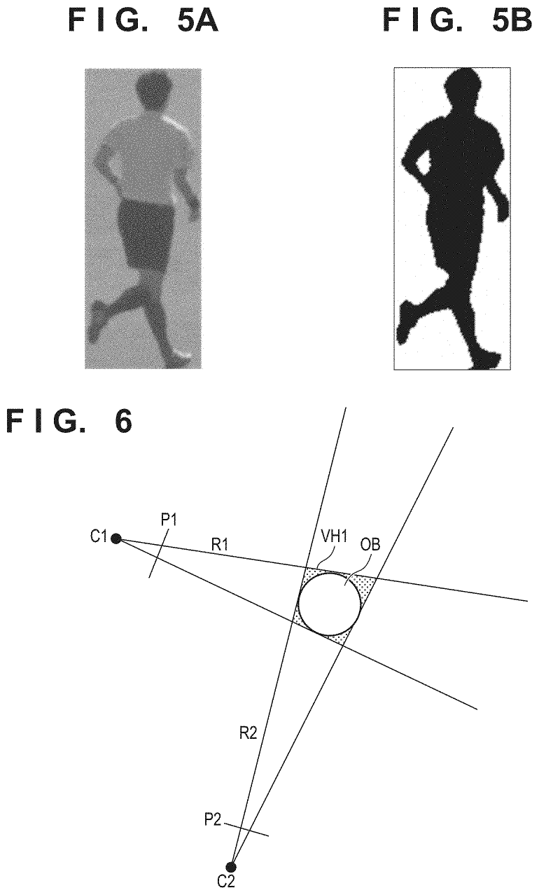

At step S401, the 3D model generating unit 230 obtains, from the image obtaining unit 210, data of the images obtained by image capturing with the plurality of cameras 110a to 110m. At step S402, the 3D model generating unit 230 extracts, from the images obtained by the plurality of cameras, a partial image as a foreground image, in which an object is captured. Here, the object refers to a subject such as a person, a small article, or an animal, for example. An example of an extracted foreground image is illustrated in FIG. 5A.

At step S403, the 3D model generating unit 230 generates a silhouette image of the object based on the extracted foreground image. A silhouette image is an image in which the object is depicted in black and other regions in white. FIG. 5B illustrates an example of a silhouette image. Although the generation method for a silhouette image is not particularly limited, a well-known background difference method or the like can be used.

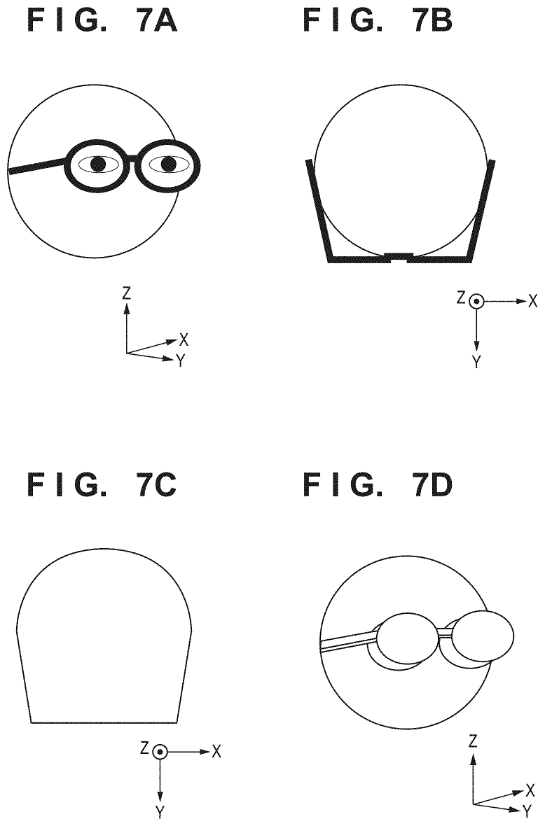

At step S404, the 3D model generating unit 230 generates a 3D model, based on the generated silhouette image and the camera parameters obtained from the parameter obtaining unit 220. It is assumed in the present embodiment to use volume intersection method (shape from silhouette method) as a non-limiting generation method of a 3D model. The generation method of a 3D model will be described, referring to FIG. 6 and FIGS. 7A to 7D.

FIG. 6 is a schematic diagram of 3D model generation according to the volume intersection method when using two number of cameras. In FIG. 6, C1 and C2 represent the camera center, P1 and P2 represent the image plane of respective cameras, R1 and R2 represent rays of light passing through the silhouette contour of the object, OB represents the object, and VH1 represents the 3D model obtained by projecting silhouettes of P1 and P2, respectively. Although FIG. 6 illustrates a case of using two cameras, it is possible to bring the shape of the 3D model VH1 closer to the shape of the object OB by increasing the number of cameras and shooting from various directions.

Furthermore, generation of a 3D model of the head when the object is a person wearing eyeglasses will be described, referring to FIGS. 7A to 7D. Here, an item including a transparent part such as eyeglasses is also referred to as a transparent object in the following description. FIGS. 7A to 7D are explanatory diagrams of generation of a 3D model of the head of a person wearing eyeglasses, according to the volume intersection method. FIG. 7A is a schematic diagram of the head of a person wearing eyeglasses. FIG. 7B is a view of the head of a person wearing eyeglasses seen from above the head in the negative direction of the Z axis. When generating a 3D model according to the volume intersection method, the shape of the contour including the eyeglasses is extracted as a silhouette, as described referring to FIG. 6. In other words, a 3D model as illustrated in FIG. 7C is generated as a result, when seen from above the head in the negative direction of the Z axis. When seen diagonally from the front, it turns out to be a 3D model as though the person is wearing swimming goggles, as illustrated in FIG. 7D.

(Specifying Process of Transparent Part)

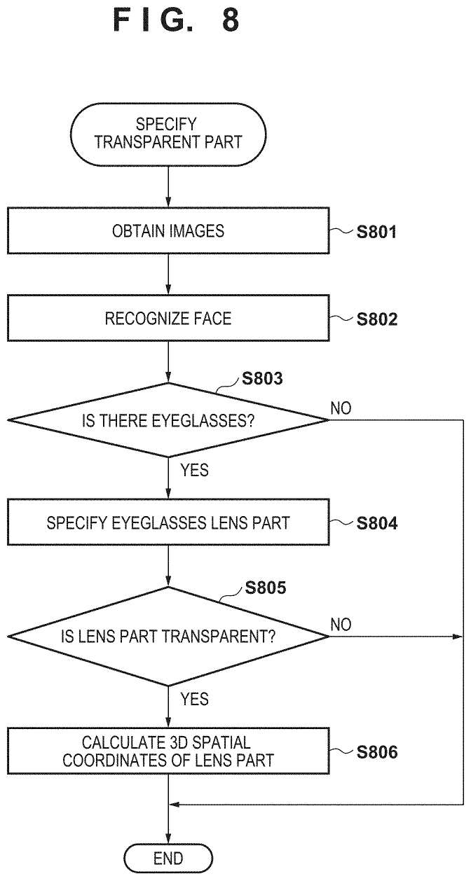

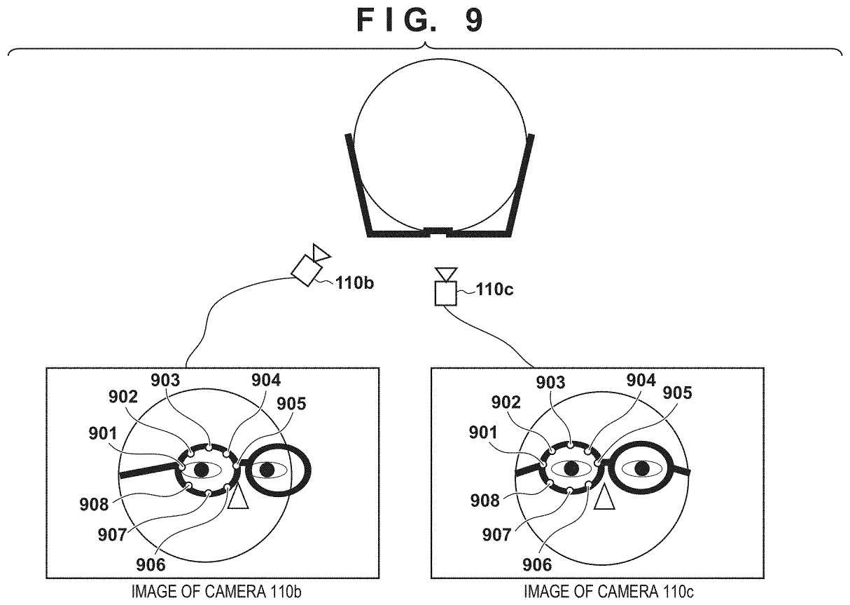

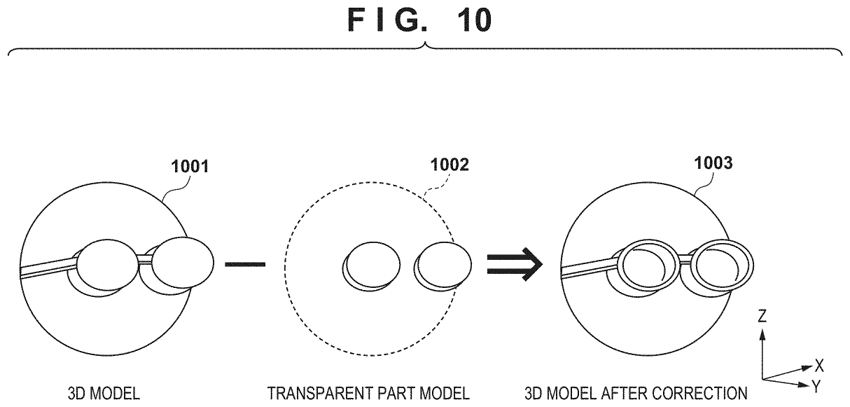

A specifying process of a transparent part according to the present embodiment will be described, referring to FIGS. 8 and 9. FIG. 8 is a flowchart of a process executed by the transparent part specifying unit 240. The flowchart illustrated in FIG. 8 may be realized by executing, by the CPU 311 of the image processing apparatus 130, a control program stored in the ROM 312 or the like to calculate and process information, and control each hardware.

At step S801, the transparent part specifying unit 240 obtains, from the image obtaining unit 210, data of the images obtained by image capturing with the plurality of cameras 110a to 110m. At step S802, the transparent part specifying unit 240 recognizes the face of the person from the images obtained by the plurality of cameras. The recognition method is not particularly limited. For example, face recognition may be performed with a learned model which has been learned using images of the faces of persons.

At step S803, the transparent part specifying unit 240 determines whether or not the recognized face wears eyeglasses. When it is determined that the face wears eyeglasses (Yes at S803), the process proceeds to step S804, when it is determined that the face does not wear eyeglasses (No at S803) the process is terminated.

At step S804, the transparent part specifying unit 240 estimates the eyeglass frame and specifies a lens part of the eyeglasses. In order to specify the lens part, the following steps may be taken. Specifically, it is also conceivable to specify, from the plurality of images, a plurality of eyeglass frame outer peripheral feature points and a plurality of lens side feature points and, based on the feature points, estimate/calculate three-dimensional shape information of the eyeglass frame and specify a part surrounded by the eyeglass frame as the lens part. Here, the method for specifying the lens part (transparent part) is not limited thereto.

At step S805, the transparent part specifying unit 240 determines whether or not the lens part specified at step S804 is transparent. In other words, the transparent part specifying unit 240 identifies whether or not the face (object) of the person includes a transparent part. When it is determined that the lens part is transparent (Yes at S805), the process proceeds to step S806, when it is determined that the lens part is not transparent (No at S805) the process is terminated. Here, whether or not the lens part is transparent may be determined by, for example, whether or not an image of the eye appears on the lens part. In other words, the transparent part specifying unit 240 can determine that the lens part is transparent when (at least a part of) an image of the eye appears on the lens part, and that the lens part is not transparent when an image of the eye does not appear on the lens part. Alternatively, the determination (identification) can be performed using machine learning.

At step S806, the transparent part specifying unit 240 calculates 3D spatial coordinates of the lens part of the eyeglasses, based on the positions of the feature points of the eyeglass frame on the respective image data and the camera parameters obtained from the parameter obtaining unit 220. For example, the transparent part specifying unit 240 can extract, from the feature points used for estimation of the eyeglass frame at step S804, a plurality of feature points coinciding on the images captured by the plurality of cameras, and calculate the 3D spatial coordinates of the lens part from the plurality of extracted feature points and the camera parameters.

A specific example of the process at step S806 will be described, referring to FIG. 9. FIG. 9 is an explanatory diagram of calculation of the 3D spatial coordinates of the lens part. In FIG. 9, for example, it is possible to calculate the 3D spatial coordinates of the lens part from the feature points 901 to 908 in the image data obtained by the camera 110b, the feature points 901 to 908 in the image data obtained by the camera 110c, and the camera parameters of respective cameras. Here, although there are eight feature points extracted in FIG. 9, the number of points to be extracted is not limited thereto. In addition, although FIG. 9 illustrates the feature points of the eyeglass frame around the lens part on one side, 3D spatial coordinates of the lens part on the other side can also be calculated by a process with respect to similar feature points.

(3D Model Correction Process)

There will be described a 3D model correction process in the present embodiment, referring to FIG. 10. FIG. 10 is a schematic diagram for explaining the 3D model correction process performed by the 3D model correcting unit 250. The 3D model correcting unit 250 performs correction on the 3D model generated by the 3D model generating unit 230 by deleting a transparent part model configured by including the 3D spatial coordinates calculated by the transparent part specifying unit 240.

In FIG. 10, a 3D model 1001 represents a 3D model generated by the 3D model generating unit 230, and a transparent part model 1002 represents a 3D model configured by including a 3D spatial coordinate region of the lens part calculated by the transparent part specifying unit 240. Here, the Y-axis component (thickness) of the transparent part model 1002 is configured by including the thickness of the lens part and the distance from the lens to the face of the person. The thickness of the lens part and the distance to the face of the person can be obtained by preliminarily measuring the same, or by using a method that interpolates with data at a region of the face outside the eyeglass, using a recognition method by machine learning or the like. The 3D model 1003 represents the corrected 3D model which was obtained by deleting the transparent part model 1002 from the 3D model 1001.

(Rendering Process)

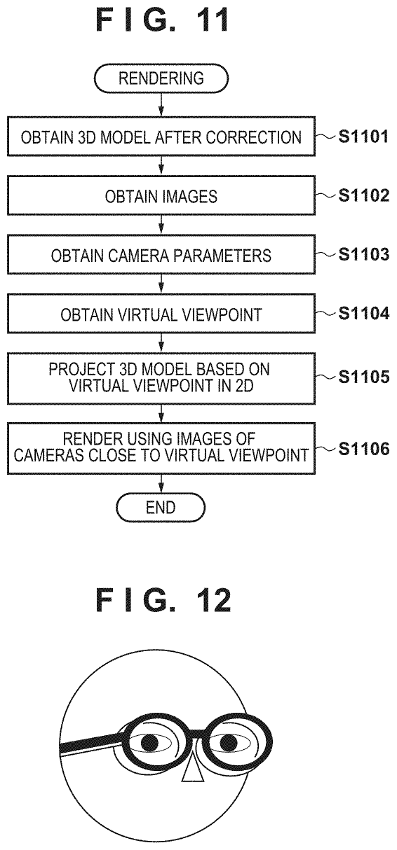

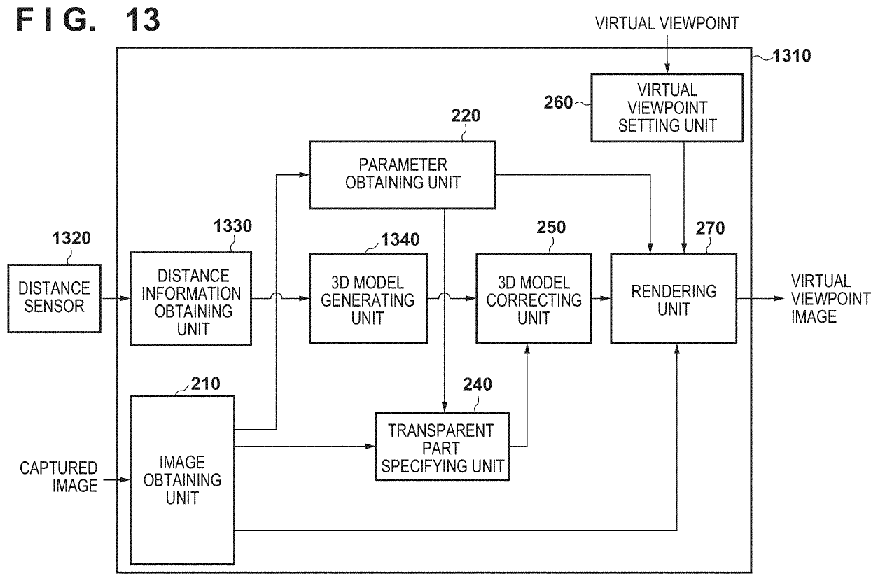

There will be described a rendering (color selection, coloring/texture pasting) process according to the present embodiment, referring to FIGS. 11 and 12. FIG. 11 is a flowchart of a process executed by the rendering unit 270 according to the present embodiment. The flowchart illustrated in FIG. 11 may be realized by executing, by the CPU 311 of the image processing apparatus 130, a control program stored in the ROM 312 or the like to calculate and process information, and control each hardware.

At step S1101, the rendering unit 270 obtains the corrected 3D model from the 3D model correcting unit 250. At step S1102, the rendering unit 270 obtains, from the image obtaining unit 210, data of images obtained by image capturing performed with the plurality of cameras 110a to 110m. At step S1103, the rendering unit 270 obtains, from the parameter obtaining unit 220, camera parameters (camera position, posture, angle of view) of the cameras 110a to 110m. At step S1104, the rendering unit 270 obtains the virtual viewpoint from the virtual viewpoint setting unit 260.

At step S1105, the rendering unit 270, having set the virtual viewpoint obtained from the virtual viewpoint setting unit 260 as the view point, projects the corrected 3D model, which was obtained from the 3D model correcting unit 250, onto a 2D (two-dimensional) plane. At step S1106, the rendering unit 270 selects images captured by one or more cameras close to the virtual viewpoint among the cameras 110a to 110m, based on the camera parameters obtained from the parameter obtaining unit 220 and, using the images, performs coloring/texture pasting on the 3D model projected onto the 2D plane. The one or more cameras are selected in the order of closeness to the virtual viewpoint, for example. FIG. 12 illustrates an example of a virtual viewpoint image (3D model) obtained after rendering by the rendering unit 270. Unlike the virtual viewpoint image according to the prior art illustrated in FIG. 17, a texture image of the eyes is pasted on a location near the region of the face enclosed by the eyeglasses in the image illustrated in FIG. 12. As such, it becomes possible to generate a virtual viewpoint image without any sense of unnaturalness also for a person wearing eyeglasses.

As has been described above, the present embodiment performs rendering (color selection, coloring/texture pasting) after deleting the transparent part model (transparent part), and therefore allows for generating a virtual viewpoint image with reduced sense of unnaturalness without having to separately generate a 3D model of an item including a transparent part (transparent object) such as an eyeglass frame. Furthermore, the present embodiment performs rendering after deleting the transparent part model, whereby the present embodiment is also applicable to generation of a virtual viewpoint image for a person wearing a transparent object other than eyeglasses, such as a face shield. For example, the transparent part may be a pet bottle or the like. In other words, it is also possible to apply the present embodiment for generation of a virtual viewpoint image of a person holding a pet bottle in his or her hand.

### Second Embodiment

Although the first embodiment uses a method for generating a 3D model based on images of a subject captured from a plurality of directions, it is also possible to generate a 3D model using a distance sensor or a 3D scanner. In the present embodiment, there will be described a method for generating a 3D model using a distance sensor. Here, description of parts common with those of the first embodiment will be omitted.

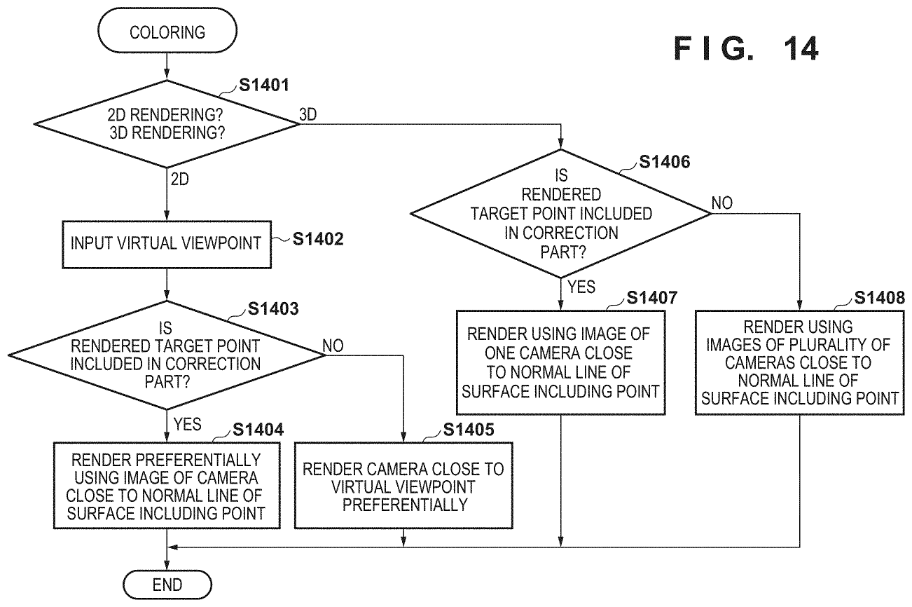

FIG. 13 illustrates a functional configuration of an image processing apparatus 1310 according to the present embodiment. The image processing apparatus 1310 includes a distance information obtaining unit 1330 configured to obtain distance information from an external distance sensor 1320, and a 3D model generating unit 1340 configured to generate a 3D model based on the obtained distance information.

The distance sensor 1320 irradiates, for example, laser or infrared light to obtain reflection, measures the distance to the object (from the distance sensor 1320), and generates distance information (distance data). The distance information obtaining unit 1330 may obtain a plurality of pieces of distance information indicating the distance from the distance sensor 1320 to the object, and configure (calculate) a 3D model of the object from the information. Here, the 3D model generating unit 1340 can generate a 3D model equivalent to that of FIG. 7D described in the first embodiment.

The present embodiment differs from the first embodiment in that the information used to generate the 3D model is the distance information obtained from the distance sensor 1320. The process described referring to FIGS. 8 to 12 is similar to that of the first embodiment, and therefore description thereof will be omitted.

As has been described above, the present embodiment deletes, similarly to the first embodiment, the transparent part model from the 3D model generated from the distance information obtained from the distance sensor 1320, and from the images captured by the plurality of cameras. As a result, it is possible to generate a virtual viewpoint image without any sense of unnaturalness.

### Third Embodiment

In the first and second embodiments, a case has been described where a uniform rendering process is performed regardless of whether or not a part to be rendered is a part corrected by the 3D model correcting unit 250 (e.g., a part contacting the deleted transparent part model), and whether the virtual viewpoint image to be output is 2D or 3D. In the present embodiment, there will be described processes in a case of performing rendering in consideration of the foregoing. Here, description of processes other than those performed by the rendering unit 270 according to the present embodiment is similar to those of the first and second embodiments.

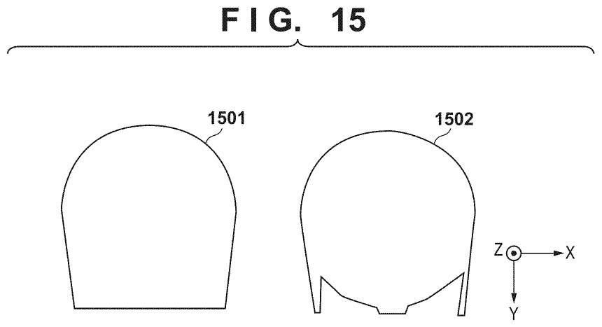

The rendering process (color selection, coloring/texture pasting) according to the present embodiment will be described, referring to FIGS. 14 to 16. FIG. 14 is a flowchart of a process executed by the rendering unit 270 according to the present embodiment. The flowchart illustrated in FIG. 14 may be realized by executing, by the CPU 311 of the image processing apparatus 130, a control program stored in the ROM 312 or the like to calculate and process information, and control each hardware.

At step S1401, the rendering unit 270 determines whether the virtual viewpoint image to be output is 2D or 3D. i.e., which of 2D rendering or 3D rendering is to be performed. Here, 2D rendering is a rendering method of performing 2D projection of the 3D model onto a plane and determining a captured image to be used for rendering in accordance with the virtual viewpoint (similarly to the first embodiment). 3D rendering is a method of rendering the 3D model itself independent of the virtual viewpoint. The determination at step S1401 may be performed based on user operation via the input apparatus 140, or which of 2D rendering or 3D rendering is to be performed may be determined in the system in advance. When 2D rendering is to be performed, the process proceeds to step S1402, or the process proceeds to step S1406 when 3D rendering is to be performed.

At step S1402, the rendering unit 270 obtains the virtual viewpoint from the virtual viewpoint setting unit 260. At step S1403, the rendering unit 270 determines whether or not the part to be rendered (also referred to as the rendering target point or element) is included in the part corrected by the 3D model correcting unit 250 (e.g., the part contacting the deleted transparent part model). When the rendering target point is included in the corrected part (Yes at S1403), the process proceeds to step S1404, otherwise (No at S1403) the process proceeds to step S1405.

At step S1404, the rendering unit 270 performs rendering, preferentially using an image captured by a camera located close to the normal line of a surface including the rendering target point (element) (e.g., using images captured by one or more cameras selected in the order of closeness to the normal line). At step S1405, the rendering unit 270 performs rendering, preferentially using an image captured by a camera located close to the virtual viewpoint (e.g., using images captured by one or more cameras selected in the order of closeness to the virtual viewpoint).

When performing 3D rendering, the rendering unit 270 determines, at step S1406, whether or not the rendering target point is included in the part corrected by the 3D model correcting unit 250. In a case where the rendering target point is included in the corrected part (Yes at S1406), the process proceeds to step S1407, otherwise (No at S1406) the process proceeds to step S1408.

At step S1407, the rendering unit 270 performs rendering using an image captured by a single camera located closest to the normal line of the plane including the rendering target point. The reason for using only the image captured by a single camera is because the shape after correction of deleting the transparent part model, such as the part including the lens part, often turns out to be concave.

At step S1408, the rendering unit 270 performs rendering using images captured by a plurality of cameras including the camera located close to the normal line of the plane including the rendering target point (e.g., using images captured by a plurality of cameras selected in the order of closeness to the normal line). The reason for using a plurality of images captured by a plurality of cameras is because the shape before correction is convex, and therefore the images captured by the plurality of cameras are synthesized and performed coloring so that the color does not change rapidly.

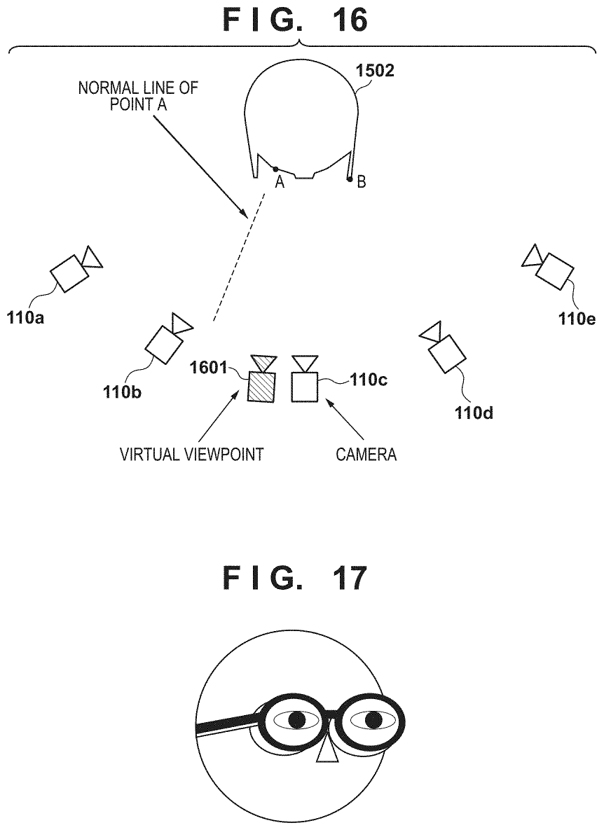

Next, a rendering process according to the present embodiment will be described, referring to FIGS. 15 and 16. FIG. 15 illustrates a view when the 3D model of the head of a person wearing eyeglasses is seen from above in the negative direction of the Z-axis. In FIG. 15, there is illustrated a 3D model 1501 before correction (deletion of the transparent part model) and a 3D model 1502 after correction. The 3D model 1502 turns out to be a 3D model with the transparent part model (lens part of eyeglasses and data of space between lens and the face) having been deleted with respect to the 3D model 1501.

FIG. 16 is an explanatory diagram of a rendering process on the 3D model 1502 (3D model after correction). In FIG. 16, it is assumed that the cameras 110a to 110e are arranged in a manner surrounding the 3D model 1502 from the front surface, and points A and B (rendering target points) seen from the virtual viewpoint 1601 are to be 2D-rendered. The point A on the 3D model 1502 is a point located behind the lens of the eyeglasses and therefore included in the corrected part (contacting the deleted transparent part model). On the other hand, point B is a point located on the frame of the eyeglasses and therefore not included in the corrected part.

Since the point A is included in the corrected part (Yes at step S1403 in FIG. 14), the rendering unit 270 performs rendering, preferentially using the image captured by the camera 110b located close to the normal line of the surface including the point A. On the other hand, since the point B is not included in the corrected part, the rendering unit 270 performs rendering, preferentially using the image captured by the camera 110c located close to the virtual viewpoint 1601. As a result, it becomes possible to perform coloring taking into account the original color of the object, while providing a higher priority to the appearance from the virtual viewpoint.

As has been described above, the present embodiment changes the rendering process depending on whether or not the part in the 3D model to be rendered is a part corrected by the 3D correction unit, and whether the virtual viewpoint image to be output is 2D or 3D. Accordingly, it becomes possible to perform coloring of the 3D model with a color close to the original color, for example. In addition, it is possible to generate a preferable virtual viewpoint image according to the output by performing rendering with different methods of selecting an image to be used for rendering in accordance with the type/form of the virtual viewpoint image to be output. Here, although the present embodiment allows selection between 2D rendering and 3D rendering, it is also possible to implement either one thereof.

As such, the embodiments described above allow for, in a case where the object includes an item including transparent parts such as eyeglasses, generating a virtual viewpoint image with reduced sense of unnaturalness without having to separately generate a 3D model of the item.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-032037, filed Mar. 1, 2021, which is hereby incorporated by reference herein in its entirety.

What is claimed is:

1. A generation apparatus comprising:
one or more memories storing instructions; and
one or more processors that, upon executing the stored instructions, perform:
obtaining an image captured by shooting an object with a plurality of image capturing devices;
specifying, in the obtained image, a transparent part included in the object or a transparent part contacting the object; and
generating a three-dimensional shape data of the object, not including the specified transparent part.

2. The apparatus according to claim 1, the one or more processors further perform:
generating first three-dimensional shape data of the object, including the specified transparent part; and
generating second three-dimensional shape data corresponding to the specified transparent part,
wherein the three-dimensional shape data of the object, not including the specified transparent part, is generated by deleting the generated second three-dimensional shape data from the generated first three-dimensional shape data.

3. The apparatus according to claim 2, wherein the generating causes the first three-dimensional shape data to be generated based on the image.

4. The apparatus according to claim 2,
the one or more processors further perform obtaining information of distance to the object,
wherein the first three-dimensional shape data is generated based on the information of the distance.

5. The apparatus according to claim 2, wherein the second three-dimensional shape data is generated using machine learning.

6. The apparatus according to claim 1, wherein the object includes the head of a person, and the transparent part includes a lens part of eyeglasses.

7. The apparatus according to claim 1, wherein the object includes the head of a person, and the transparent part includes a face shield.

8. A system comprising:
one or more memories storing instructions; and
one or more of processors that, upon executing the stored instructions, perform:
obtaining an image captured by shooting an object with a plurality of image capturing devices;
specifying, in the obtained image, a transparent part included in the object or a transparent part contacting the object;
generating a three-dimensional shape data of the object, not including the specified transparent part;
obtaining virtual viewpoint information for specifying a position of a virtual viewpoint and a view direction from the virtual viewpoint; and
generating a virtual viewpoint image representing appearance from the virtual viewpoint, based on the generated three-dimensional shape data, and images obtained with one or more image capturing devices selected from the plurality of image capturing devices based on the virtual viewpoint information.

9. The system according to claim 8, the one or more processors further perform:
generating first three-dimensional shape data of the object, including the specified transparent part; and
generating second three-dimensional shape data corresponding to the specified transparent part,
wherein the three-dimensional shape data of the object, not including the specified transparent part, is generated by deleting the generated second three-dimensional shape data from the generated first three-dimensional shape data.

10. The system according to claim 9, wherein, a color corresponding to an element included in a part, of the generated three-dimensional shape data, which has become a surface due to deleting the transparent part, is determined based on images obtained with one or more image capturing devices selected from the plurality of image capturing devices in an order of closeness to a normal line of a surface in the three-dimensional shape data including the element.

11. The system according to claim 9,
wherein in generating the virtual viewpoint image,
a color corresponding to an element included in a part, of the generated three-dimensional shape data, which has become a surface due to deleting the transparent part, is determined based on an image obtained with one image capturing device selected from the plurality of image capturing devices in an order of closeness to a normal line of a surface in the three-dimensional shape data including the element, and
a color corresponding to an element not included in the part, of the generated three-dimensional shape data, is determined based on images obtained with the plurality of image capturing devices selected in the order of closeness to the normal line.

12. A generation method comprising:
obtaining an image captured by shooting an object with a plurality of image capturing devices;
specifying, in the obtained image, a transparent part included in the object or a transparent part contacting the object; and
generating a three-dimensional shape data of the object, not including the specified transparent part.

13. A non-transitory computer-readable storage medium storing a program that causes a computer to execute a generation method, the method comprising:
obtaining an image captured by shooting an object with a plurality of image capturing devices;
specifying, in the obtained image, a transparent part included in the object or a transparent part contacting the object; and
generating a three-dimensional shape data of the object, not including the specified transparent part.
